(19) United States
(12) Patent Application Publication
(10) Pub. No.: US 2023/0123573 A1
(43) Pub. Date: Apr. 20, 2023

(54) AUTOMATIC DETECTION OF SEASONAL PATTERN INSTANCES AND CORRESPONDING PARAMETERS IN MULTI-SEASONAL TIME SERIES

(71) Applicant: Oracle International Corporation, Redwood Shores, CA (US)

(72) Inventors: Chirag Ahuja, Delhi (IN); Samik Raychaudhuri, Bangalore (IN); Anku Kumar Pandey, New Delhi (IN); Nitin Rawat, New Delhi (IN)

(73) Assignee: Oracle International Corporation, Redwood Shores, CA (US)

(21) Appl. No.: 17/861,634

(22) Filed: Jul. 11, 2022

(30) Foreign Application Priority Data
Oct. 18, 2021 (IN) 202141047045

(51) Int. Cl. G06F 17/18; G06F 16/2458; G06F 17/14

(52) U.S. Cl. CPC G06F 17/18; G06F 16/2477; G06F 16/2462; G06F 17/14

(57) ABSTRACT

The present embodiments relate to generating input parameters for selecting a forecasting model. An example method includes a computing device receiving a time series comprising a plurality of data points, wherein each data point of the time series comprises a time associated with the data point and a value. The device can identify a first season and a second season from the time series, wherein a length of the first season is a factor of a length of the second season. The device can estimate a Fourier order and a seasonality mode for the first season based at least in part on the length of the first season and the length of the second season. The device can select a forecasting model to forecast a value of a future time step of the time series based at least in part on the Fourier order and the seasonality mode.

### CROSS-REFERENCES TO RELATED APPLICATIONS

The present application claims the benefit of Indian provisional application number 202141047045, filed Oct. 18, 2021, which is incorporated by reference.

### BACKGROUND

A cloud service provider (CSP) can provide multiple cloud services to subscribing customers. These services are provided under different models, including a Software-as-a-Service (SaaS) model, a Platform-as-a-Service (PaaS) model, an Infrastructure-as-a-Service (IaaS) model, and others. In many instances, a cloud services provider can offer on-demand services, such as a forecasting service.

### SUMMARY

The present embodiments relate to identifying seasons in a time series, and to generating both a Fourier order and a seasonality type of the time series for use in forecasting. A first example embodiment relates to a method for deriving parameters relating to identified first seasonal pattern instances in time series for the selection of a forecasting model. The method can include receiving a time series comprising a plurality of data points, wherein each data point of the time series comprises a time associated with the data point and a value.

The method can also include identifying a first season and a second season from the time series, wherein a length of the first season is a factor of a length of the second season.

The method can also include estimating a Fourier order for the first season based at least in part on the length of the first season and the length of the second season.

The method can also include estimating a seasonality mode of the first season based at least in part on the length of the first season and the length of the second season.

The method can also include selecting a forecasting model to forecast a value of a future time step of the time series based at least in part on the Fourier order and the seasonality mode.

Another example embodiment relates to a computing device. The computing device can include a processor and a computer-readable medium. The computer-readable medium can include instructions stored thereon that, when executed by the processor, cause the processor to receive a time series comprising a plurality of data points, wherein each data point of the time series comprises a time associated with the data point and a value.

The instructions can further cause the processor to identify a first season and a second season from the time series, wherein a length of the first season is a factor of a length of the second season.

The instructions can further cause the processor to estimate a Fourier order for the first season based at least in part on the length of the first season and the length of the second season.

The instructions can further cause the processor to estimate a seasonality mode of the first season based at least in part on the length of the first season and the length of the second season.

The instructions can further cause the processor to select a forecasting model to forecast a value of a future time step of the time series based at least in part on the Fourier order and the seasonality mode.

Another example embodiment relates to a non-transitory computer-readable medium. The non-transitory computer-readable medium can include stored thereon a sequence of instructions which, when executed by a processor, causes the processor to execute a process. The process can comprise receiving a time series comprising a plurality of data points, wherein each data point of the time series comprises a time associated with the data point and a value.

The process can also include identifying a first season and a second season from the time series, wherein a length of the first season is a factor of a length of the second season.

The process can also include estimating a Fourier order for the first season based at least in part on the length of the first season and the length of the second season.

The process can also include estimating a seasonality mode of the first season based at least in part on the length of the first season and the length of the second season.

The process can also include selecting a forecasting model to forecast a value of a future time step of the time series based at least in part on the Fourier order and the seasonality mode.

### BRIEF DESCRIPTION OF DRAWINGS

FIG. 1 is a block diagram of system 100 for identifying a season, estimating a Fourier order, and estimating a seasonality mode for a time series, in accordance with some embodiments.

FIG. 2 includes graphical representations of an ACF periodicity and a periodogram periodicity, in accordance with some embodiments

FIG. 3 is an example process flow for grouping together seasons, in accordance with some embodiments.

FIG. 4 is an example process flow for rescoring, in accordance with some embodiments.

FIG. 5 is an example process flow for estimating a Fourier order for an identified season, in accordance with some embodiments.

FIG. 6 is an example process flow for deriving parameters relating to identified seasons in a time series for the selection of a forecasting model, in accordance with some embodiments.

FIG. 7 is a block diagram illustrating a pattern for implementing a cloud infrastructure as a service system, according to at least one embodiment.

FIG. 8 is a block diagram illustrating another pattern for implementing a cloud infrastructure as a service system, according to at least one embodiment.

FIG. 9 is a block diagram illustrating another pattern for implementing a cloud infrastructure as a service system, according to at least one embodiment.

FIG. 10 is a block diagram illustrating another pattern for implementing a cloud infrastructure as a service system, according to at least one embodiment.

FIG. 11 is a block diagram illustrating an example computer system, according to at least one embodiment.

### DETAILED DESCRIPTION

In the following description, various embodiments will be described. For purposes of explanation, specific configurations and details are set forth to provide a thorough understanding of the embodiments. However, it will also be apparent to one skilled in the art that the embodiments may be practiced without the specific details. Furthermore, well-known features may be omitted or simplified in order not to obscure the embodiment being described.

A time series can include a series of data points with varying values associated with different times over a time period. As used herein, the time associated with each value can also be known as a time step. A forecasting model can be employed to use the time series to forecast one or more values at future times. The time series can include one or more seasons that can be identified within the time series. A season can include an identifiable and repeating pattern (e.g., each day, week, or month) within the time series. As an illustration, a person's spending habits can continuously decrease from receipt of a paycheck to the day before a next paycheck arrives. This pattern can repeat itself each season (e.g., bi-weekly pay period) within a time series collected over, for example, one year. Additionally, the time series can include multiple sub-seasons within a season. The forecasting model should accurately identify the seasons and sub-seasons to generate accurate forecasted values for the future times.

Furthermore, a time series can further be additive or multiplicative, and the forecasting model should be additive or multiplicative to match the time series. In an additive time series, a trend in the time series values is linear, wherein the trend is a general change over time. For example, if a time series has values that exhibit an increasing trend, the increase will be relatively constant over time. In a multiplicative time series, a time series trend is non-linear. For example, if a time series has an increasing trend, the increase will not be constant over time. As described herein, the seasonality mode is whether the time series is additive or multiplicative.

Conventional forecasting systems can receive a time series and employ forecasting models to generate values for future times. These forecasting systems can analyze the received time series to identify parameters such as the seasons and related data within the time series. These parameters determine how accurately the forecasting model can generate the forecasted values. These forecasting systems further employ brute force or other time-consuming and computationally expensive methods, such as Bayesian optimization or linear optimization, for identifying these parameters. For example, if a conventional system receives a time series with five years of collected data, the system may brute force its way through numerous potential seasonal periods to determine an optimal period to explain the time series. In some instances, the forecasting system could simulate seasons from a one-day season up to a five-year season to determine an optimal season. Furthermore, the forecasting model may simulate each season as an additive time series or a multiplicate time series, which doubles the number of calculations that need to be performed to determine to not only identify an optimal season but the seasonality mode as well.

The embodiments described herein address the above-referenced issues by presenting a forecasting methodology for estimating the above-referenced forecasting parameters without the conventional brute force or computationally expensive techniques of the above-described systems. The herein-described method can be used to identify various parameters such as seasons, an estimated Fourier order of the identified seasons, and an estimated time series mode. These parameters can be provided to a forecasting model, such that the model does not have to apply the above-referenced brute force or computationally expensive methods to identify any optimal seasons and time series mode. The forecasting model can receive the parameters and the time series and generate forecasted values for the time series.

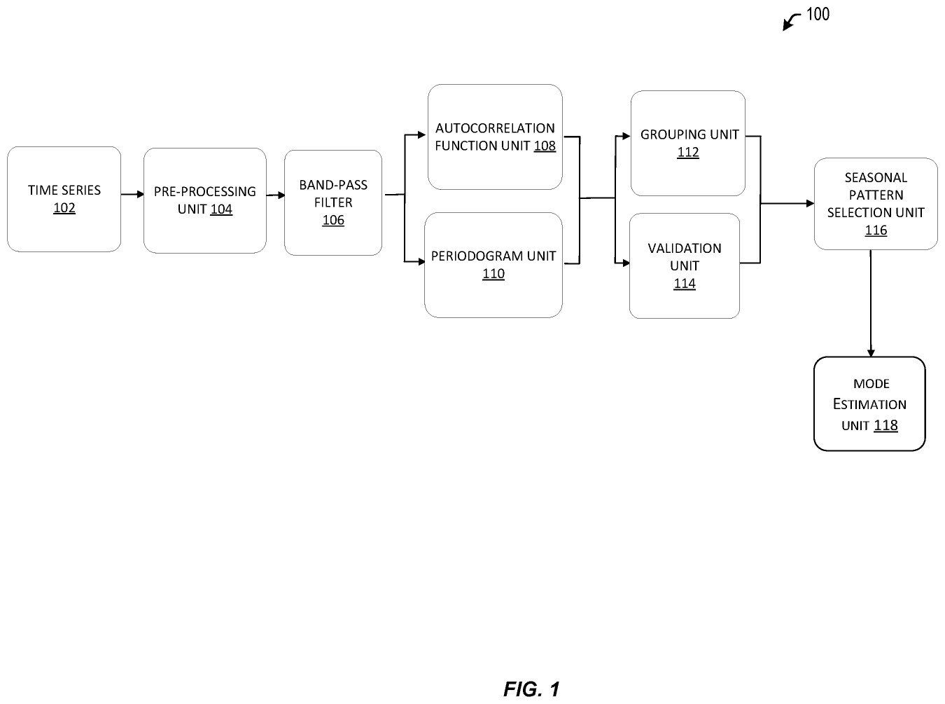

FIG. 1 is a block diagram of system 100 for identifying a season, estimating a Fourier order, and estimating a seasonality mode for a time series, in accordance with some embodiments. A cloud infrastructure node included in a cloud infrastructure service can be configured to perform the processing tasks as described herein. A computing device can ingest a time series 102. The time series 102 can include data points, including a value and a time step indicating a creation time of the value. An example time series 102 can include a computing device's performance values during a time period, population figures, climate values, etc.

The time series 102 can be processed by a pre-processing unit 104, which can include cleaning the time series 102, (e.g., by identifying null values in the time series and converting the time series into a matrix format). The pre-processing unit 104 can further derive values to replace with null values and prepare the time series 102 for processing.

The time series 102 can be filtered via a band-pass filter 106. The time series 102 can be represented by a waveform that includes an alternating current (AC) component and a direct current (DC) component, with an amplitude and frequency that correspond to a value at a given time step. The band-pass filter 106 can infer frequencies of the time series 102 (e.g., weekly, monthly frequencies) and filter out unwanted frequencies. The band-pass filter 106 can further remove a portion (e.g., the DC component of the waveform) of the time series 102.

The time series 102 can be further processed to identify seasons in the time-domain, such as via an autocorrelation function (ACF) unit 108. The ACF unit 108 can detect seasons in the time series that are identifiable in the time-domain. The ACF unit 108 can identify seasons in the time series 102 by introducing various time lags. For example, the ACF unit 108 can shift the time series 102 by one or more time steps to generate a lagged time series. The ACE unit 108 can further remove one or more data points from the original time series based on the number of shifts. For example, the time series can include ten data points (OTS₀, . . . , OTS₉) and the ACF unit 108 can shift the time series by one time step to generate a lagged time series (LTS₁, . . . , LTS₉). The ACF unit 108 can further remove one data point from the original time series such that the original time series includes (OTS₀, . . . , OTS₈). The ACF unit 108 can calculate an autocorrelation value between the two time series (e.g., (LTS₁, . . . , LTS₉) to (OTS₀, . . . , OTS₈). The ACF unit 108 can increase the lag length and repeat this process. For each time shift, the ACF unit 108 can calculate an autocorrelation value between the original time series 102 and the lagged time series, where the higher the autocorrelation value, the more likely a season has been identified. A comparison of the autocorrelation values can be used to identify seasons in the time series in the time-domain.

The time series 102 can also be processed to identify seasons in the frequency-domain, such as via a periodogram unit 110. The time series 102 can be processed in parallel by the ACF unit 108 and the periodogram unit 110 as described herein. The periodogram unit 110 can receive the time series 102 and apply a discrete Fourier transform (DFT) to represent the time series 102 in the frequency-domain. The periodogram unit 110 can identify seasons in the time series 102 in the frequency-domain. The periodogram unit 110 can identify amplitude vs. frequency characteristics of the time series 102. An output of periodogram unit 110 can be more robust to noise than a time-domain analysis of the time series 102, given that the discrete Fourier transform can be decomposition-based.

The system 100 can reconcile the frequency-domain and time-domain outputs (e.g., identified seasons) of the ACF unit 108 and the periodogram unit 110. The system 100 can reconcile these outputs such that both outputs are with respect to the time-domain, for example, via an inverse Fourier transform. The reconciled outputs of the ACF unit 108 and the periodogram unit 110 can be grouped and validated to identify seasons in the time series.

The grouping unit 112 can receive the outputs and derive one or more groupings of pluralities. The outputs can be grouped can be based on the seasons identified by the ACF unit 108 and the periodogram unit 110. The groups can be based on identified seasons that have lengths with common factors, wherein lengths can be a number of time steps of the season. For example, if seasons of length two weeks, four weeks, seven weeks, ten weeks, and thirty-five weeks. The grouping unit 112 can create a first group of seasons of length two weeks, four weeks, and ten weeks, where two weeks is the common factor. The grouping unit can create a second group of seven weeks, and thirty-five weeks were seven weeks in the common factor.

The validation unit 114 can validate the outputs of the ACF unit 108 and the periodogram unit 110 in parallel with the grouping unit 112. The validation unit 114 can rescore the identified seasons to determine a correctness of each season. In other words, the validation unit 114 can determine whether any of the identified seasons are actually present in the time series. The validation process can also include a rescoring and combining of the outputs.

The season selection unit 116 can select seasons from the outputs of the grouping unit 112 based on the rescoring of the validation unit 114. The season selection unit 116 can further determine a strength of correlation between an identified seasons and the time series 102. The season selection unit 116 can select the season of the number of seasons a strongest correlation with the time series 102 based on the rescoring of the validation unit 114.

The mode estimation unit 118 can estimate a seasonal mode. The seasonality mode can help determine a projected increase in the time series over time. The seasonality mode can be either an additive seasonality or a multiplicative seasonality. An additive seasonality can include a linear change in the values of the time series over time. On the other hand, a multiplicative seasonality can have the non-linear trend, for example, an exponential trend.

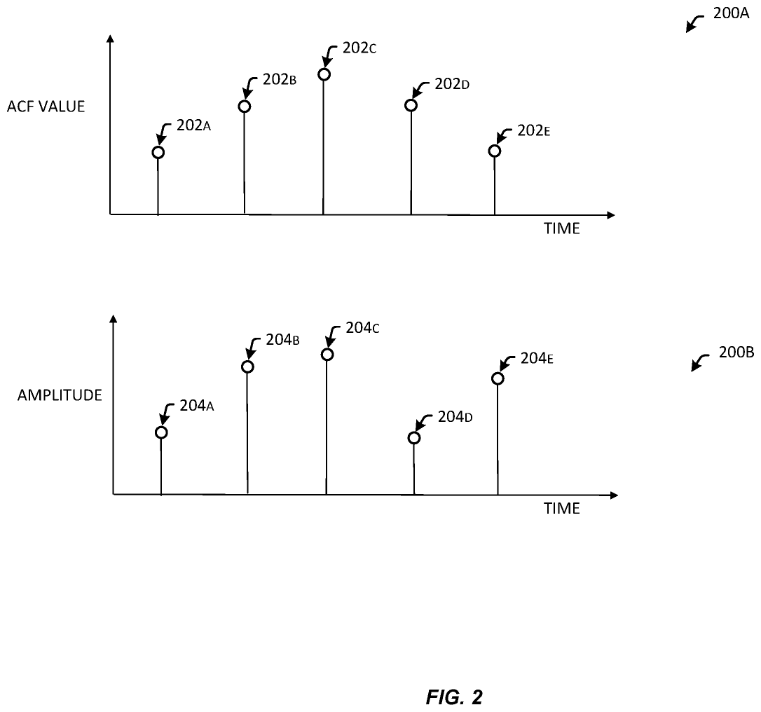

FIG. 2 includes graphical representations of an ACF periodicity 200A and a periodogram periodicity 200B, in accordance with some embodiments. For instance, an ACF periodicity 200A can specify a number of points 202A-E specifying autocorrelation values in the time-domain. The ACF periodicity 200A can provide an x-axis comprising time and a y-axis comprising correlation. Further, a periodogram periodicity 200B can specify a number of points 204A-E specifying correlations in the time series. The periodogram periodicity 200B can provide an x-axis comprising a frequency and a y-axis comprising an amplitude. The points 204A-E resulting from the periodogram function can be processed to only comprise portions of the time series correlated to one another.

The output data from the ACF function and the periodogram function can be reconciled to derive grouped factors common between both sets of output data. The grouped factors can be further processed using a combining and rescoring process as described herein.

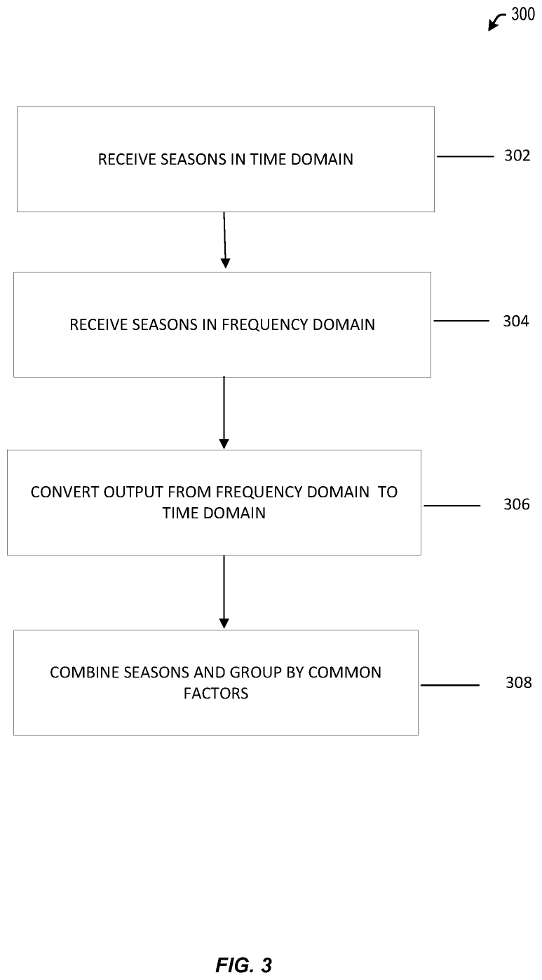

FIG. 3 is an example process flow 300 for grouping together seasons, in accordance with some embodiments. At 302, a computing device can receive the identified seasons represented in the time-domain. For example, the computing device can receive the identified seasons from an ACF unit 108. For example, the ACF unit 108 can detect seasons that repeat every 12-, 14-, 21-, 24-, 49-, and 360-time steps. In other words, the seasons have respective lengths of 12-, 14-, 21-, 49-, and 360-time steps. The ACF unit 108 can provide these identified seasons to the computing device.

At 304, a computing device can receive identified seasons represented in the frequency-domain. For example, a periodogram unit 110 can detect seasons that repeat every 7-, 14-, 21-, 30-, and 120-time steps. Each time step can refer to a number of seconds, days, months, or other period based on the time series. In this instance, the computing device can detect that the 12 is a factor of 36.

At 306, the computing device can transform the representation in the frequency-domain to a representation in the time-domain. For example, the computing device can apply an inverse Fourier transform to the output of the periodogram unit 110.

At 308, the computing device can group together the seasons based on having lengths with common factors. The grouping unit 112 can combine the identified seasons to create a combined set of seasons, for example, 7-, 12-, 14-21-, 30-, 49-, 120-, and 360-time steps. The computing device can create a first group of 7-, 14-, 21-, and 49-time steps; a second group of 12- and 120-time steps; and a third group of 30-, 120-, and 360-time steps.

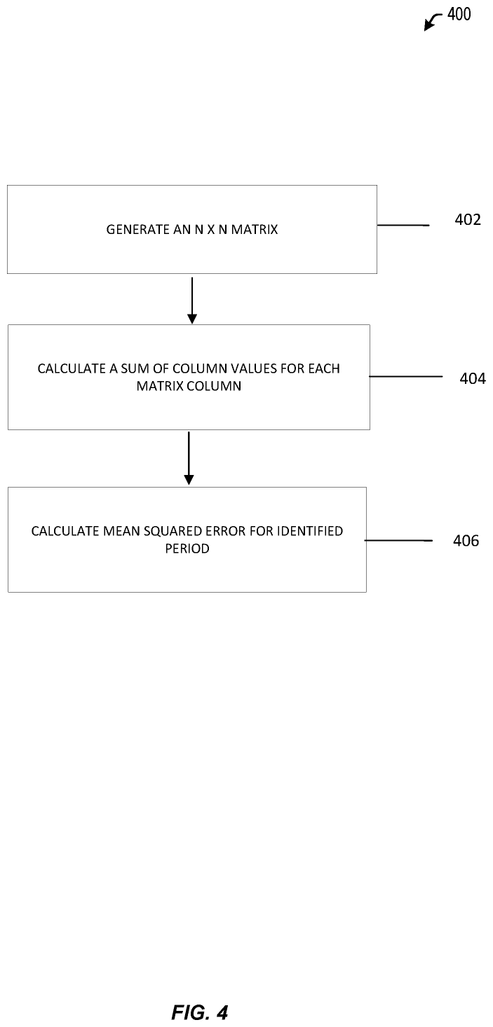

FIG. 4 is an example process flow 400 for rescoring, in accordance with some embodiments. The rescoring process can result, for example, in the ranking of each of the seasons identified by the grouping unit 112. As described above, at 402, a computing device can receive a time series and generate an n×n matrix based on selected season length. The identified length can be, for example, as provided by a grouping unit 112. For example, the computing device can receive the following time series TS=[1, . . . , 36] and generate a 6×6 matrix, as illustrated below

$$Y = \begin{matrix}1 & 2 & 3 & 4 & 5 & 6 \\ 7 & 8 & 9 & 10 & 11 & 12 \\ 13 & 14 & 15 & 16 & 17 & 18 \\ 19 & 20 & 21 & 22 & 23 & 24 \\ 25 & 26 & 27 & 28 & 29 & 30 \\ 31 & 32 & 33 & 34 & 35 & 36\end{matrix} , \qquad ( 1 )$$

where six is one of the season lengths identified by the grouping unit 112. For example, the grouping unit 112 can have identified a grouping of factors (6, 36). Furthermore, the numbers, 1-36, displayed above are index numbers, and each index number is for a data point associated with a time step and a value. It should be appreciated that, in some embodiments, the computing device can perform these steps for a selected season length of, for example, eighteen, as eighteen is a multiple of six and less than or equal to thirty-six as identified by the grouping of factors. In other embodiments, the computing device can perform these steps for only the minimum value of each group. For example, for the group (6, 36), the computing device only performs the process for six.

At 402, the computing device can calculate sums Xᵢ for the column values. For example, the computing device can calculate X₁=(Y[1]+, . . . +Y[31]), . . . , X₆=(Y[6]+, . . . , +Y[36]), where S₁=(X₁, . . . , X₆). Ideally, if the time series does have season of length six, each value of a column will be the same or substantially similar (e.g., Y[1]=, . . . , =Y[31]).

At 404, the computing device can calculate a squared summation (X²ᵢ) of each column in the matrix. For example, the computing device can calculate X²₁=(Y²[1]+, . . . , +Y²[31]), where S²₂=(X²₁, . . . , X²₆). The squared summation (X²ᵢ) can be used in deriving the mean squared error (MSE) for the season.

At 406, the computing device can calculate an MSE for the season using X²₁. The computing device can calculate an MSE for each identified season length. The computing device can rank each identified season length based on the respective MSE. For example, the computing device can perform an MSE regression analysis to compare the MSE for each identified season length to a regression line. The regression line can be calculated using a portion of the time series. For example, the time series can be divided into a testing portion and a reference portion, where the data points of the testing portion are associated with time points that occur before the time points of the reference portion. The computing device can forecast values using the testing portion and compare the forecasted values to actual values from the reference portion.

As described above, a Fourier order can be derived for each season (e.g., specifying a season of the time series) identified from the time series. The Fourier order can include a value indicative of a frequency or strength of an identified season. For example, a higher Fourier order can correlate to a higher frequency/strength between the identified season and the time series. The Fourier order can be used to select seasons from the time series and the selection of a forecasting model.

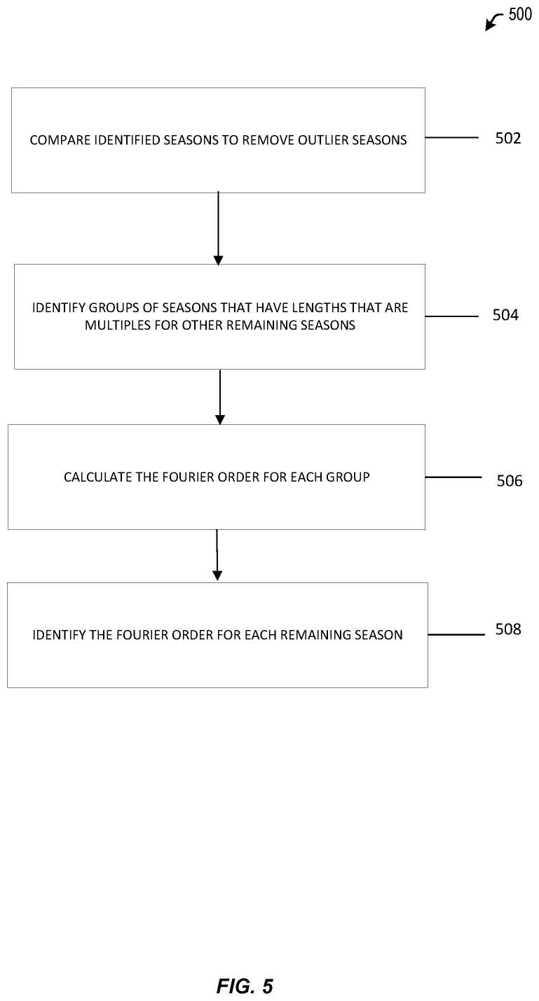

FIG. 5 is an example process flow 500 for estimating a Fourier order for an identified season, in accordance with some embodiments. At 502, a computing device can turn a representation of the identified seasons in the frequency-domain. The computing device can compare each identified season to a threshold maximum and a threshold minimum to remove any outlier seasons.

At 504, the computing device can identify any of the remaining seasons that are multiples of another remaining season. In other words, seasons that have lengths with a common factor as described above.

At 506, the computing device can calculate an estimated Fourier order for each group. The estimated Fourier order can be estimated as the longest identified season divided by the shortest identified season of a group. For example, the computing device can identify a group, including a season with length of six time steps and a season with length of seventy-two time steps. In the case, the estimated Fourier order for this group can be twelve (e.g., 72/6=12).

At 506, the computing device can identify remaining seasons that have similar lengths but are not factors of other lengths. Using the example above, in addition to a season having a length of six, the computing device can receive a season of length seven and another season of length eight (e.g., 6, 7, 8). The distance between the season with the common factor length (e.g., 6) and the similar values can be a threshold distance. The computing device can replace one or more values with a reference value. For example, as illustrated eight has a distance of two from six, but in other instances the distance can be lower or greater. The reference value can be a value that is meaningful for a forecasting task. For example, a forecasting task can be related to forecasting a temperature with five years' worth of collected data. Furthermore, for forecasting temperature, a season of length six can be a known reference length. In this case, the computing device can treat the seasons of length seven and eight as being a season of length six.

At 508, the computing device can determine an estimated Fourier order based on a set of pre-configured rules. The rules can further equate a season length with an estimated Fourier order. The computing device can identify seasons having unique lengths, such as lengths that are not factors of or season having lengths that are similar to other seasons and determine the estimated Fourier order based on the rules.

In a conventional forecasting system, time series are analyzed with respect to multiple Fourier orders. In other words, the conventional forecasting system will iteratively use a brute force process to analyze a time series with respect to different candidate seasons and different candidate Fourier orders. The conventional forecasting system will then compare the results derived using each candidate season and each candidate Fourier order. The embodiments described herein permit a forecasting system to receive the top-performing seasons and estimated Fourier order to avoid these iterations of time series analysis for less desirable candidate seasons and less desirable Fourier orders.

As described above, a mode of seasonality can be identified and used with a Fourier order to select a model to forecast time series data. The mode of seasonality can be either additive or multiplicative. An additive mode of seasonality can include a cumulative addition of time series data values over time. A multiplicative mode of seasonality can include time series data values multiplying over time.

Identifying both the Fourier order and the mode of seasonality can allow for the efficient identification of an optimized model for forecasting time series data. For instance, without identifying the seasons in the time series, a Fourier order, and/or a mode of seasonality, a portion of time series may be fitted to a plurality of models in an attempt to find an optimized model.

A computing device can identify a multiplicative residual value, Y_{Multiplicativeresidual}, each identified season. The multiplicative residual value can be based on data relating to the identified season (Y), a trend, Y_{Trend}, and seasonal data Yₛₑₐₛₒₙₛ, for the identified season. Trend data can include a trend line derived from a DC component portion of the time series data associated with the period. The DC component portion of the time series data can be identified, for example, via a band-bass filter.

Seasonal data can include cumulative seasonal data derived for an identified period. For example, as described with respect to FIG. 4, a value, Y[x], for an indexed column to a period can be identified. The seasonal data can include an accumulation of all season values according to the period and a frequency multiplier for the period. For example, in a grouping, if a maximum length (Y) of a season is 72 and a minimum length of the season includes 6, the frequency multiple is 12. The seasonal data can include a season value multiplied by the frequency multiple. Accordingly, a multiplicative residual value can be calculated as follows:

$$Ymultiplicativeresidual = \frac{Y}{Ytrend - Yseasons} \qquad ( 2 )$$

The computing device can calculate an additive residual value (Y_{Additiveresidual}) can for each identified season. The additive residual value can include a difference in the seasonal data from the trend as follows:

YAdditiveresidual=Ytrend−Yseasons (3)

The computing device can estimate a seasonality mode based on an R squared error analysis for each of the additive residual value and multiplicative residual value can be performed to determine a mode of seasonality. An R-squared analysis can include a statistical measure of how close the data are to the fitted regression line. The R-squared error analysis can include processing each residual value with an ACF. If an R-squared error value for the additive residual is less than a R-squared error value for the multiplicative residual, the mode of seasonality can include an additive mode.

If, however, the R-squared error value for the additive residual is greater than the R-squared error value for the multiplicative residual, the mode of seasonality can include a multiplicative mode. The mode of seasonality can be determined for each identified (or selected) period and used for forecasting the time series data.

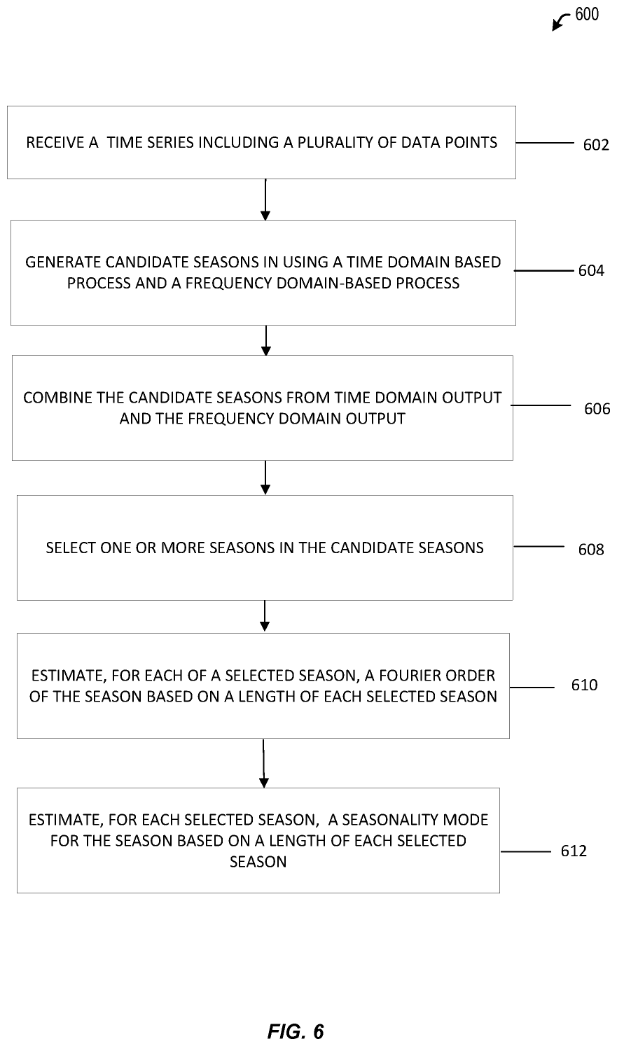

FIG. 6 is an example process flow 600 for deriving parameters relating to identified seasons in a time series for the selection of a forecasting model, in accordance with some embodiments. The derived parameters (e.g., ranked seasons, Fourier order, and seasonality type) can be used to efficiently select an optimized model for forecasting the time series. At 602, a computing device can receive a time series, including a plurality of data points. Each data point can include a timestamp specifying a time of capturing the data point and a value. A value can provide an amplitude of various parameters for the time series, such as a weather-related parameter (e.g., temperature, precipitation), a computing resource parameter (e.g., computing processing resource usage, data throughput speed, latency, delay), a business-related parameter (e.g., sales, profits, inventory levels), etc.

In some embodiments, the computing device can pre-process the time series. The pre-processing process can include converting the time series into a matrix format according to the timestamps for each of the plurality of data points. The time series in the matrix format can include a number of null data points specifying time instances in which no data was captured. The number of null data points can be identified in the converted time series.

In these embodiments, the pre-processing can include deriving an optimized value of the converted time series by performing a factorization of the converted time series. For example, an alternating least square optimization process can be performed based on a length of the time series. The optimized values can be replaced with the number of null data points to increase efficiency in processing the time series.

At 604, the computing device can generate candidate seasons in the frequency-domain and the time-domain, for example, by using an ACF to generate an output in the time-domain, and a periodogram function to generate an output in the frequency-domain output. The ACF can perform a time-based correlation analysis of portions of the time series to identify candidate seasons and candidate sub-seasons in the time series. For example, the candidate season can include a week, month, etc., in which values in the time series repeat after each season.

The periodogram function can include performing a discrete Fourier transform analysis process to generate the output in the frequency-domain. The periodogram function can specify a frequency-domain spectral density of the time series at various seasons. The frequency-based output data can identify candidate seasons in the frequency-domain.

At 606, the computing device can convert one of the outputs into the domain of the other and combine the outputs. For instance, the computing device can convert the frequency-domain output into the time-domain via, for example, an inverse Fourier transform. The computing device can then combine the outputs represented in a single domain, for example, the time-domain.

At 608, the computing device can select one or more seasons in the time series based on the candidate seasons. The computing device can evaluate each candidate season using MSE as described with respect to FIG. 4.

At 610, the computing device can estimate, for each selected season, a Fourier order of the season based on the length of the season. The computing device can estimate the Fourier order based on various inputs. For example, the computing device can estimate the Fourier order based on factor-based season groupings, a similarity in identified seasons to a reference season, and rules-based approach for identified seasons that cannot be categorized for the first two inputs. An example method for estimating the Fourier order is described with more particularity with respect to FIG. 5.

At 612, the computing device can estimate, for each selected season, a seasonality mode based on the lengths of the selected seasons. The seasonality mode can be either additive or multiplicative. The derived Fourier order and seasonality mode for each of the identified seasons can be used in selecting a model for forecasting the time series.

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, load balancing, and clustering, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed may first need to be set up. In some instances, the provisioning can be done manually, a provisioning tool may be utilized to provision the resources, and/or deployment tools may be utilized to deploy the code once the infrastructure is provisioned.

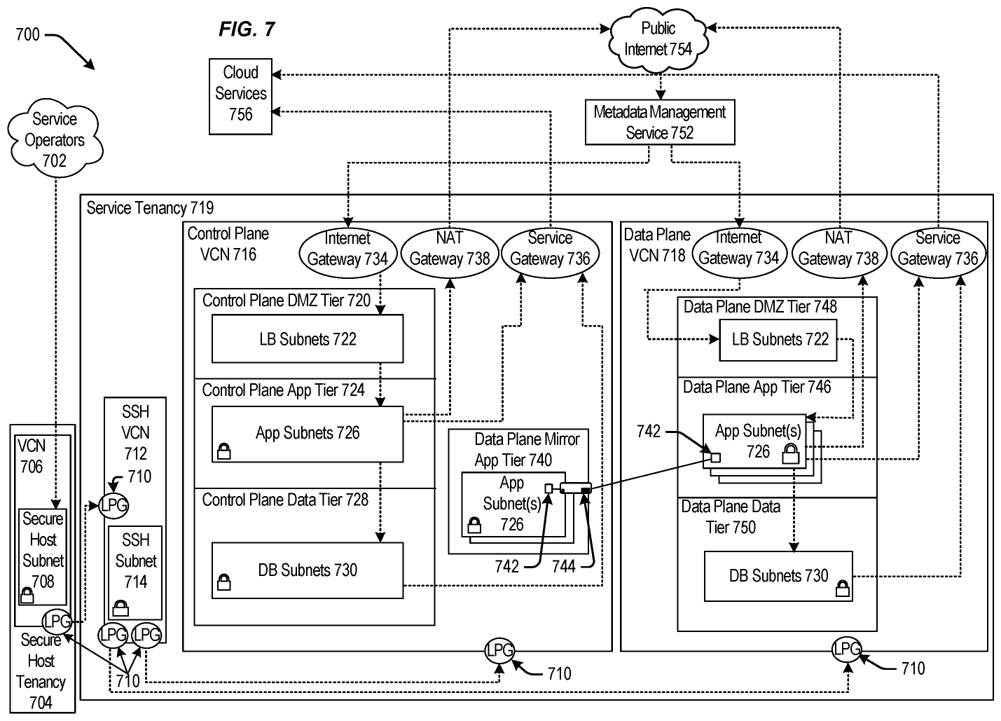

FIG. 7 is a block diagram 700 illustrating an example pattern of an IaaS architecture, according to at least one embodiment. Service operators 702 can be communicatively coupled to a secure host tenancy 704 that can include a virtual cloud network (VCN) 706 and a secure host subnet 708. In some examples, the service operators 702 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 14, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 706 and/or the Internet.

The VCN 706 can include a local peering gateway (LPG) 710 that can be communicatively coupled to a secure shell (SSH) VCN 712 via an LPG 710 contained in the SSH VCN 712. The SSH VCN 712 can include an SSH subnet 714, and the SSH VCN 712 can be communicatively coupled to a control plane VCN 716 via the LPG 710 contained in the control plane VCN 716. Also, the SSH VCN 712 can be communicatively coupled to a data plane VCN 718 via an LPG 710. The control plane VCN 716 and the data plane VCN 718 can be contained in a service tenancy 719 that can be owned and/or operated by the IaaS provider.

The control plane VCN 716 can include a control plane demilitarized zone (DMZ) tier 720 that acts as a perimeter network (e.g., portions of a corporate network between the corporate intranet and external networks). The DMZ-based servers may have restricted responsibilities and help keep breaches contained. Additionally, the DMZ tier 720 can include one or more load balancer (LB) subnet(s) 722, a control plane app tier 724 that can include app subnet(s) 726, a control plane data tier 728 that can include database (DB) subnet(s) 730 (e.g., frontend DB subnet(s) and/or backend DB subnet(s)). The LB subnet(s) 722 contained in the control plane DMZ tier 720 can be communicatively coupled to the app subnet(s) 726 contained in the control plane app tier 724 and an Internet gateway 734 that can be contained in the control plane VCN 716, and the app subnet(s) 726 can be communicatively coupled to the DB subnet(s) 730 contained in the control plane data tier 728 and a service gateway 736 and a network address translation (NAT) gateway 738. The control plane VCN 716 can include the service gateway 736 and the NAT gateway 738.

The control plane VCN 716 can include a data plane mirror app tier 740 that can include app subnet(s) 726. The app subnet(s) 726 contained in the data plane mirror app tier 740 can include a virtual network interface controller (VNIC) 742 that can execute a compute instance 744. The compute instance 744 can communicatively couple the app subnet(s) 726 of the data plane mirror app tier 740 to app subnet(s) 726 that can be contained in a data plane app tier 746.

The data plane VCN 718 can include the data plane app tier 746, a data plane DMZ tier 748, and a data plane data tier 750. The data plane DMZ tier 748 can include LB subnet(s) 722 that can be communicatively coupled to the app subnet(s) 726 of the data plane app tier 746 and the Internet gateway 734 of the data plane VCN 718. The app subnet(s) 726 can be communicatively coupled to the service gateway 736 of the data plane VCN 718 and the NAT gateway 738 of the data plane VCN 718. The data plane data tier 750 can also include the DB subnet(s) 730 that can be communicatively coupled to the app subnet(s) 726 of the data plane app tier 746.

The Internet gateway 734 of the control plane VCN 716 and of the data plane VCN 718 can be communicatively coupled to a metadata management service 752 that can be communicatively coupled to public Internet 754. Public Internet 754 can be communicatively coupled to the NAT gateway 738 of the control plane VCN 716 and of the data plane VCN 718. The service gateway 736 of the control plane VCN 716 and of the data plane VCN 718 can be communicatively couple to cloud services 756.

In some examples, the service gateway 736 of the control plane VCN 716 or of the data plane VCN 718 can make application programming interface (API) calls to cloud services 756 without going through public Internet 754. The API calls to cloud services 756 from the service gateway 736 can be one-way: the service gateway 736 can make API calls to cloud services 756, and cloud services 756 can send requested data to the service gateway 736. But, cloud services 756 may not initiate API calls to the service gateway 736.

In some examples, the secure host tenancy 704 can be directly connected to the service tenancy 719, which may be otherwise isolated. The secure host subnet 708 can communicate with the SSH subnet 714 through an LPG 710 that may enable two-way communication over an otherwise isolated system. Connecting the secure host subnet 708 to the SSH subnet 714 may give the secure host subnet 708 access to other entities within the service tenancy 719.

The control plane VCN 716 may allow users of the service tenancy 719 to set up or otherwise provision desired resources. Desired resources provisioned in the control plane VCN 716 may be deployed or otherwise used in the data plane VCN 718. In some examples, the control plane VCN 716 can be isolated from the data plane VCN 718, and the data plane mirror app tier 740 of the control plane VCN 716 can communicate with the data plane app tier 746 of the data plane VCN 718 via VNICs 742 that can be contained in the data plane mirror app tier 740 and the data plane app tier 746.

In some examples, users of the system, or customers, can make requests, for example create, read, update, or delete (CRUD) operations, through public Internet 754 that can communicate the requests to the metadata management service 752. The metadata management service 752 can communicate the request to the control plane VCN 716 through the Internet gateway 734. The request can be received by the LB subnet(s) 722 contained in the control plane DMZ tier 720. The LB subnet(s) 722 may determine that the request is valid, and in response to this determination, the LB subnet(s) 722 can transmit the request to app subnet(s) 726 contained in the control plane app tier 724. If the request is validated and requires a call to public Internet 754, the call to public Internet 754 may be transmitted to the NAT gateway 738 that can make the call to public Internet 754. Memory that may be desired to be stored by the request can be stored in the DB subnet(s) 730.

In some examples, the data plane mirror app tier 740 can facilitate direct communication between the control plane VCN 716 and the data plane VCN 718. For example, changes, updates, or other suitable modifications to configuration may be desired to be applied to the resources contained in the data plane VCN 718. Via a VNIC 742, the control plane VCN 716 can directly communicate with, and can thereby execute the changes, updates, or other suitable modifications to configuration to, resources contained in the data plane VCN 718.

In some embodiments, the control plane VCN 716 and the data plane VCN 718 can be contained in the service tenancy 719. In this case, the user, or the customer, of the system may not own or operate either the control plane VCN 716 or the data plane VCN 718. Instead, the IaaS provider may own or operate the control plane VCN 716 and the data plane VCN 718, both of which may be contained in the service tenancy 719. This embodiment can enable isolation of networks that may prevent users or customers from interacting with other users', or other customers', resources. Also, this embodiment may allow users or customers of the system to store databases privately without needing to rely on public Internet 754, which may not have a desired level of threat prevention, for storage.

In other embodiments, the LB subnet(s) 722 contained in the control plane VCN 716 can be configured to receive a signal from the service gateway 736. In this embodiment, the control plane VCN 716 and the data plane VCN 718 may be configured to be called by a customer of the IaaS provider without calling public Internet 754. Customers of the IaaS provider may desire this embodiment since database(s) that the customers use may be controlled by the IaaS provider and may be stored on the service tenancy 719, which may be isolated from public Internet 754.

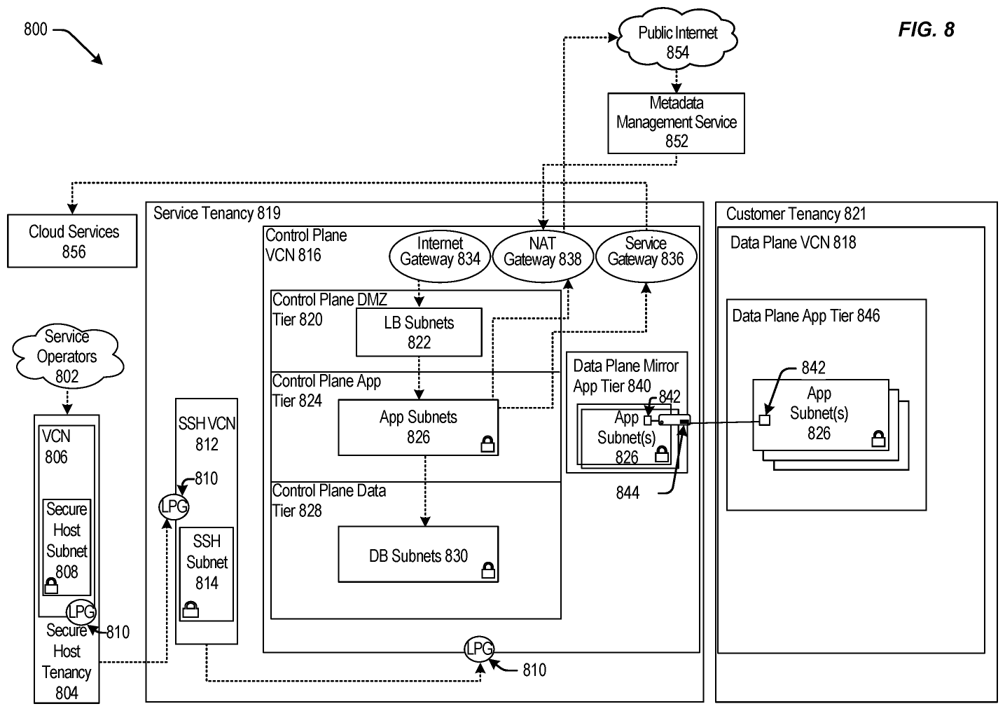

FIG. 8 is a block diagram 800 illustrating another example pattern of an IaaS architecture, according to at least one embodiment. Service operators 802 (e.g., service operators 702 of FIG. 7) can be communicatively coupled to a secure host tenancy 804 (e.g., the secure host tenancy 704 of FIG. 7) that can include a virtual cloud network (VCN) 806 (e.g., the VCN 706 of FIG. 7) and a secure host subnet 808 (e.g., the secure host subnet 708 of FIG. 7). The VCN 876 can include a local peering gateway (LPG) 810 (e.g., the LPG 710 of FIG. 7) that can be communicatively coupled to a secure shell (SSH) VCN 812 (e.g., the SSH VCN 712 of FIG. 7) via an LPG 810 contained in the SSH VCN 812. The SSH VCN 812 can include an SSH subnet 814 (e.g., the SSH subnet 714 of FIG. 7), and the SSH VCN 812 can be communicatively coupled to a control plane VCN 816 (e.g., the control plane VCN 716 of FIG. 7) via an LPG 810 contained in the control plane VCN 816. The control plane VCN 816 can be contained in a service tenancy 819 (e.g., the service tenancy 719 of FIG. 7), and the data plane VCN 818 (e.g., the data plane VCN 718 of FIG. 7) can be contained in a customer tenancy 821 that may be owned or operated by users, or customers, of the system.

The control plane VCN 816 can include a control plane DMZ tier 820 (e.g., the control plane DMZ tier 720 of FIG. 7) that can include LB subnet(s) 822 (e.g., LB subnet(s) 722 of FIG. 7), a control plane app tier 824 (e.g., the control plane app tier 724 of FIG. 7) that can include app subnet(s) 826 (e.g., app subnet(s) 726 of FIG. 7), a control plane data tier 828 (e.g., the control plane data tier 728 of FIG. 7) that can include database (DB) subnet(s) 830 (e.g., similar to DB subnet(s) 730 of FIG. 7). The LB subnet(s) 822 contained in the control plane DMZ tier 820 can be communicatively coupled to the app subnet(s) 826 contained in the control plane app tier 824 and an Internet gateway 834 (e.g., the Internet gateway 734 of FIG. 7) that can be contained in the control plane VCN 816, and the app subnet(s) 826 can be communicatively coupled to the DB subnet(s) 830 contained in the control plane data tier 828 and a service gateway 836 (e.g., the service gateway 736 of FIG. 7) and a network address translation (NAT) gateway 838 (e.g., the NAT gateway 738 of FIG. 7). The control plane VCN 816 can include the service gateway 836 and the NAT gateway 838.

The control plane VCN 816 can include a data plane mirror app tier 840 (e.g., the data plane mirror app tier 740 of FIG. 7) that can include app subnet(s) 826. The app subnet(s) 826 contained in the data plane mirror app tier 840 can include a virtual network interface controller (VNIC) 842 (e.g., the VNIC of 742 of FIG. 7) that can execute a compute instance 844 (e.g., similar to the compute instance 744 of FIG. 7). The compute instance 844 can facilitate communication between the app subnet(s) 826 of the data plane mirror app tier 840 and the app subnet(s) 826 that can be contained in a data plane app tier 846 (e.g., the data plane app tier 846 of FIG. 8) via the VNIC 842 contained in the data plane mirror app tier 840 and the VNIC 842 contained in the data plane app tier 846.

The Internet gateway 834 contained in the control plane VCN 816 can be communicatively coupled to a metadata management service 852 (e.g., the metadata management service 702 of FIG. 7) that can be communicatively coupled to public Internet 854 (e.g., public Internet 704 of FIG. 7). Public Internet 854 can be communicatively coupled to the NAT gateway 838 contained in the control plane VCN 816. The service gateway 836 contained in the control plane VCN 816 can be communicatively couple to cloud services 856 (e.g., cloud services 756 of FIG. 7).

In some examples, the data plane VCN 818 can be contained in the customer tenancy 821. In this case, the IaaS provider may provide the control plane VCN 816 for each customer, and the IaaS provider may, for each customer, set up a unique compute instance 844 that is contained in the service tenancy 819. Each compute instance 844 may allow communication between the control plane VCN 816, contained in the service tenancy 819, and the data plane VCN 818 that is contained in the customer tenancy 821. The compute instance 844 may allow resources, that are provisioned in the control plane VCN 816 that is contained in the service tenancy 819, to be deployed or otherwise used in the data plane VCN 818 that is contained in the customer tenancy 821.

In other examples, the customer of the IaaS provider may have databases that live in the customer tenancy 821. In this example, the control plane VCN 816 can include the data plane mirror app tier 840 that can include app subnet(s) 826. The data plane mirror app tier 840 can reside in the data plane VCN 818, but the data plane mirror app tier 840 may not live in the data plane VCN 818. That is, the data plane mirror app tier 840 may have access to the customer tenancy 821, but the data plane mirror app tier 840 may not exist in the data plane VCN 818 or be owned or operated by the customer of the IaaS provider. The data plane mirror app tier 840 may be configured to make calls to the data plane VCN 818 but may not be configured to make calls to any entity contained in the control plane VCN 816. The customer may desire to deploy or otherwise use resources in the data plane VCN 818 that are provisioned in the control plane VCN 816, and the data plane mirror app tier 840 can facilitate the desired deployment, or other usage of resources, of the customer.

In some embodiments, the customer of the IaaS provider can apply filters to the data plane VCN 818. In this embodiment, the customer can determine what the data plane VCN 818 can access, and the customer may restrict access to public Internet 854 from the data plane VCN 818. The IaaS provider may not be able to apply filters or otherwise control access of the data plane VCN 818 to any outside networks or databases. Applying filters and controls by the customer onto the data plane VCN 818, contained in the customer tenancy 821, can help isolate the data plane VCN 818 from other customers and from public Internet 854.

In some embodiments, cloud services 856 can be called by the service gateway 836 to access services that may not exist on public Internet 854, on the control plane VCN 816, or on the data plane VCN 818. The connection between cloud services 856 and the control plane VCN 816 or the data plane VCN 818 may not be live or continuous. Cloud services 856 may exist on a different network owned or operated by the IaaS provider. Cloud services 856 may be configured to receive calls from the service gateway 836 and may be configured to not receive calls from public Internet 854. Some cloud services 856 may be isolated from other cloud services 856, and the control plane VCN 816 may be isolated from cloud services 856 that may not be in the same region as the control plane VCN 816. For example, the control plane VCN 816 may be located in “Region 1,” and cloud service “Deployment 1,” may be located in Region 1 and in “Region 2.” If a call to Deployment 1 is made by the service gateway 836 contained in the control plane VCN 816 located in Region 1, the call may be transmitted to Deployment 1 in Region 1. In this example, the control plane VCN 816, or Deployment 1 in Region 1, may not be communicatively coupled to, or otherwise in communication with, Deployment 2 in Region 2.

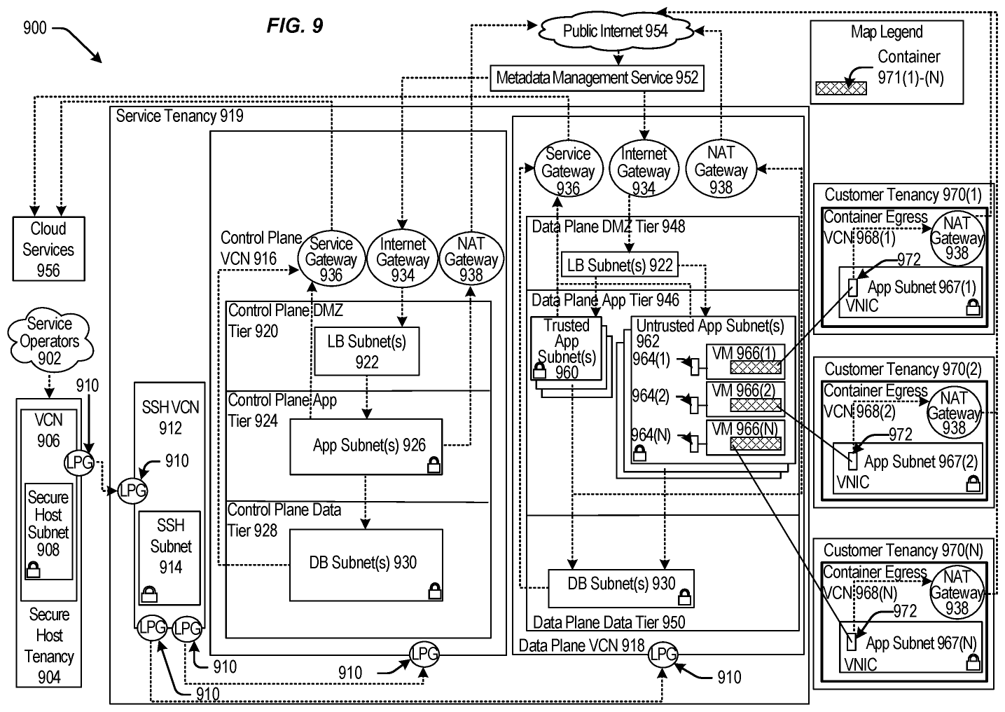

FIG. 9 is a block diagram 900 illustrating another example pattern of an IaaS architecture, according to at least one embodiment. Service operators 902 (e.g., service operators 702 of FIG. 7) can be communicatively coupled to a secure host tenancy 904 (e.g., the secure host tenancy 704 of FIG. 7) that can include a virtual cloud network (VCN) 906 (e.g., the VCN 906 of FIG. 7) and a secure host subnet 908 (e.g., the secure host subnet 708 of FIG. 7). The VCN 906 can include an LPG 910 (e.g., the LPG 710 of FIG. 7) that can be communicatively coupled to an SSH VCN 912 (e.g., the SSH VCN 712 of FIG. 7) via an LPG 910 contained in the SSH VCN 912. The SSH VCN 912 can include an SSH subnet 914 (e.g., the SSH subnet 714 of FIG. 7), and the SSH VCN 912 can be communicatively coupled to a control plane VCN 916 (e.g., the control plane VCN 716 of FIG. 7) via an LPG 910 contained in the control plane VCN 916 and to a data plane VCN 918 (e.g., the data plane 718 of FIG. 7) via an LPG 910 contained in the data plane VCN 918. The control plane VCN 916 and the data plane VCN 918 can be contained in a service tenancy 919 (e.g., the service tenancy 719 of FIG. 7).

The control plane VCN 916 can include a control plane DMZ tier 920 (e.g., the control plane DMZ tier 720 of FIG. 7) that can include load balancer (LB) subnet(s) 922 (e.g., LB subnet(s) 722 of FIG. 7), a control plane app tier 924 (e.g., the control plane app tier 724 of FIG. 7) that can include app subnet(s) 926 (e.g., similar to app subnet(s) 726 of FIG. 7), a control plane data tier 928 (e.g., the control plane data tier 728 of FIG. 7) that can include DB subnet(s) 930. The LB subnet(s) 922 contained in the control plane DMZ tier 920 can be communicatively coupled to the app subnet(s) 926 contained in the control plane app tier 924 and to an Internet gateway 934 (e.g., the Internet gateway 734 of FIG. 7) that can be contained in the control plane VCN 916, and the app subnet(s) 926 can be communicatively coupled to the DB subnet(s) 930 contained in the control plane data tier 928 and to a service gateway 936 (e.g., the service gateway 736 of FIG. 7) and a network address translation (NAT) gateway 938 (e.g., the NAT gateway 738 of FIG. 7). The control plane VCN 916 can include the service gateway 936 and the NAT gateway 938.

The data plane VCN 918 can include a data plane app tier 946 (e.g., the data plane app tier 746 of FIG. 7), a data plane DMZ tier 948 (e.g., the data plane DMZ tier 748 of FIG. 7), and a data plane data tier 950 (e.g., the data plane data tier 750 of FIG. 7). The data plane DMZ tier 948 can include LB subnet(s) 922 that can be communicatively coupled to trusted app subnet(s) 960 and untrusted app subnet(s) 962 of the data plane app tier 946 and the Internet gateway 934 contained in the data plane VCN 918. The trusted app subnet(s) 960 can be communicatively coupled to the service gateway 936 contained in the data plane VCN 918, the NAT gateway 938 contained in the data plane VCN 918, and DB subnet(s) 930 contained in the data plane data tier 950. The untrusted app subnet(s) 962 can be communicatively coupled to the service gateway 936 contained in the data plane VCN 918 and DB subnet(s) 930 contained in the data plane data tier 950. The data plane data tier 950 can include DB subnet(s) 930 that can be communicatively coupled to the service gateway 936 contained in the data plane VCN 918.

The untrusted app subnet(s) 962 can include one or more primary VNICs 964(1)-(N) that can be communicatively coupled to tenant virtual machines (VMs) 966(1)-(N). Each tenant VM 966(1)-(N) can be communicatively coupled to a respective app subnet 967(1)-(N) that can be contained in respective container egress VCNs 968(1)-(N) that can be contained in respective customer tenancies 970(1)-(N). Respective secondary VNICs 972(1)-(N) can facilitate communication between the untrusted app subnet(s) 962 contained in the data plane VCN 918 and the app subnet contained in the container egress VCNs 968(1)-(N). Each container egress VCNs 968(1)-(N) can include a NAT gateway 938 that can be communicatively coupled to public Internet 954 (e.g., public Internet 754 of FIG. 7). The Internet gateway 934 contained in the control plane VCN 916 and contained in the data plane VCN 918 can be communicatively coupled to a metadata management service 952 (e.g., the metadata management system 752 of FIG. 7) that can be communicatively coupled to public Internet 954. Public Internet 954 can be communicatively coupled to the NAT gateway 938 contained in the control plane VCN 916 and contained in the data plane VCN 918. The service gateway 936 contained in the control plane VCN 916 and contained in the data plane VCN 918 can be communicatively couple to cloud services 956.

In some embodiments, the data plane VCN 918 can be integrated with customer tenancies 970. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 946. Code to run the function may be executed in the VMs 966(1)-(N), and the code may not be configured to run anywhere else on the data plane VCN 918. Each VM 966(1)-(N) may be connected to one customer tenancy 970. Respective containers 971(1)-(N) contained in the VMs 966(1)-(N) may be configured to run the code. In this case, there can be a dual isolation (e.g., the containers 971(1)-(N) running code, where the containers 971(1)-(N) may be contained in at least the VM 966(1)-(N) that are contained in the untrusted app subnet(s) 962), which may help prevent incorrect or otherwise undesirable code from damaging the network of the IaaS provider or from damaging a network of a different customer. The containers 971(1)-(N) may be communicatively coupled to the customer tenancy 970 and may be configured to transmit or receive data from the customer tenancy 970. The containers 971(1)-(N) may not be configured to transmit or receive data from any other entity in the data plane VCN 918. Upon completion of running the code, the IaaS provider may kill or otherwise dispose of the containers 971(1)-(N).

In some embodiments, the trusted app subnet(s) 960 may run code that may be owned or operated by the IaaS provider. In this embodiment, the trusted app subnet(s) 960 may be communicatively coupled to the DB subnet(s) 930 and be configured to execute CRUD operations in the DB subnet(s) 930. The untrusted app subnet(s) 962 may be communicatively coupled to the DB subnet(s) 930, but in this embodiment, the untrusted app subnet(s) may be configured to execute read operations in the DB subnet(s) 930. The containers 971(1)-(N) that can be contained in the VM 966(1)-(N) of each customer and that may run code from the customer may not be communicatively coupled with the DB subnet(s) 930.

In other embodiments, the control plane VCN 916 and the data plane VCN 918 may not be directly communicatively coupled. In this embodiment, there may be no direct communication between the control plane VCN 916 and the data plane VCN 918. However, communication can occur indirectly through at least one method. An LPG 910 may be established by the IaaS provider that can facilitate communication between the control plane VCN 916 and the data plane VCN 918. In another example, the control plane VCN 916 or the data plane VCN 918 can make a call to cloud services 956 via the service gateway 936. For example, a call to cloud services 956 from the control plane VCN 916 can include a request for a service that can communicate with the data plane VCN 918.

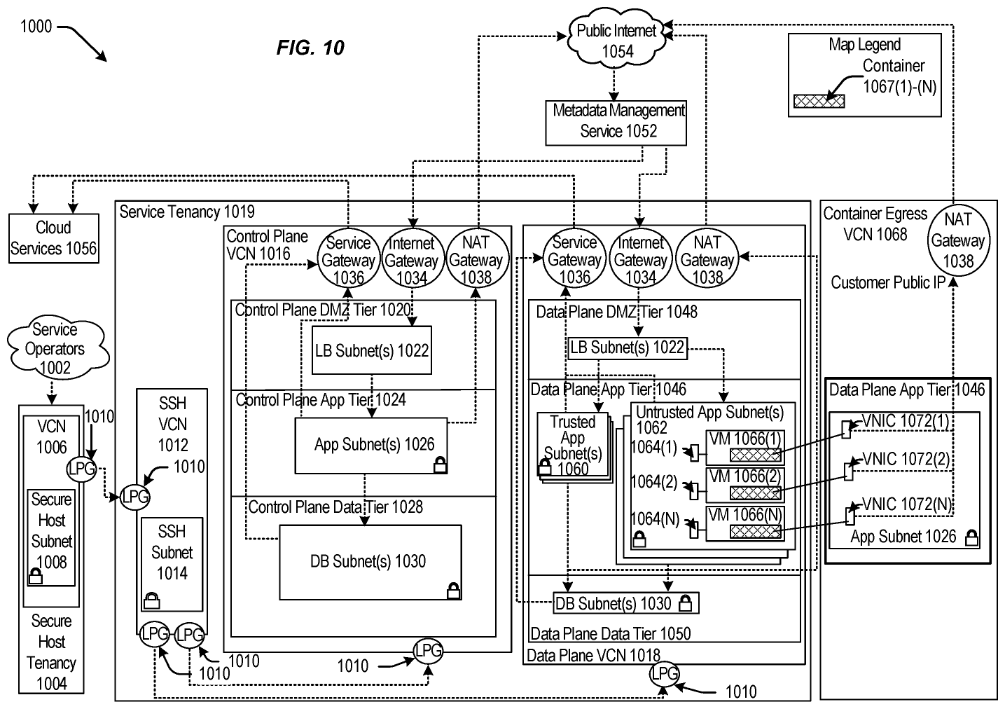

FIG. 10 is a block diagram 1000 illustrating another example pattern of an IaaS architecture, according to at least one embodiment. Service operators 1002 (e.g., service operators 702 of FIG. 7) can be communicatively coupled to a secure host tenancy 1004 (e.g., the secure host tenancy 704 of FIG. 7) that can include a virtual cloud network (VCN) 1006 (e.g., the VCN 706 of FIG. 7) and a secure host subnet 1008 (e.g., the secure host subnet 708 of FIG. 7). The VCN 1006 can include an LPG 1010 (e.g., the LPG 710 of FIG. 7) that can be communicatively coupled to an SSH VCN 1012 (e.g., the SSH VCN 712 of FIG. 7) via an LPG 1010 contained in the SSH VCN 1012. The SSH VCN 1012 can include an SSH subnet 1014 (e.g., the SSH subnet 714 of FIG. 7), and the SSH VCN 1012 can be communicatively coupled to a control plane VCN 1016 (e.g., the control plane VCN 716 of FIG. 7) via an LPG 1010 contained in the control plane VCN 1016 and to a data plane VCN 1018 (e.g., the data plane 718 of FIG. 7) via an LPG 1010 contained in the data plane VCN 1018. The control plane VCN 1016 and the data plane VCN 1018 can be contained in a service tenancy 1019 (e.g., the service tenancy 719 of FIG. 7).

The control plane VCN 1016 can include a control plane DMZ tier 1020 (e.g., the control plane DMZ tier 720 of FIG. 7) that can include LB subnet(s) 1022 (e.g., LB subnet(s) 722 of FIG. 7), a control plane app tier 1024 (e.g., the control plane app tier 724 of FIG. 7) that can include app subnet(s) 1026 (e.g., app subnet(s) 726 of FIG. 7), a control plane data tier 1028 (e.g., the control plane data tier 728 of FIG. 7) that can include DB subnet(s) 1030 (e.g., DB subnet(s) 730 of FIG. 7). The LB subnet(s) 1022 contained in the control plane DMZ tier 1020 can be communicatively coupled to the app subnet(s) 1026 contained in the control plane app tier 1024 and to an Internet gateway 1034 (e.g., the Internet gateway 734 of FIG. 7) that can be contained in the control plane VCN 1016, and the app subnet(s) 1026 can be communicatively coupled to the DB subnet(s) 1030 contained in the control plane data tier 1028 and to a service gateway 1036 (e.g., the service gateway 736 of FIG. 7) and a network address translation (NAT) gateway 1038 (e.g., the NAT gateway 738 of FIG. 7). The control plane VCN 1016 can include the service gateway 1036 and the NAT gateway 1038.

The data plane VCN 1018 can include a data plane app tier 1046 (e.g., the data plane app tier 746 of FIG. 7), a data plane DMZ tier 1048 (e.g., the data plane DMZ tier 748 of FIG. 7), and a data plane data tier 1050 (e.g., the data plane data tier 750 of FIG. 7). The data plane DMZ tier 1048 can include LB subnet(s) 1022 that can be communicatively coupled to trusted app subnet(s) 1060 (e.g., trusted app subnet(s) 960 of FIG. 9) and untrusted app subnet(s) 1062 (e.g., untrusted app subnet(s) 962 of FIG. 9) of the data plane app tier 1046 and the Internet gateway 1034 contained in the data plane VCN 1018. The trusted app subnet(s) 1060 can be communicatively coupled to the service gateway 1036 contained in the data plane VCN 1018, the NAT gateway 1038 contained in the data plane VCN 1018, and DB subnet(s) 1030 contained in the data plane data tier 1050. The untrusted app subnet(s) 1062 can be communicatively coupled to the service gateway 1036 contained in the data plane VCN 1018 and DB subnet(s) 1030 contained in the data plane data tier 1050. The data plane data tier 1050 can include DB subnet(s) 1030 that can be communicatively coupled to the service gateway 1036 contained in the data plane VCN 1018.

The untrusted app subnet(s) 1062 can include primary VNICs 1064(1)-(N) that can be communicatively coupled to tenant virtual machines (VMs) 1066(1)-(N) residing within the untrusted app subnet(s) 1062. Each tenant VM 1066(1)-(N) can run code in a respective container 1067(1)-(N), and be communicatively coupled to an app subnet 1026 that can be contained in a data plane app tier 1046 that can be contained in a container egress VCN 1068. Respective secondary VNICs 1072(1)-(N) can facilitate communication between the untrusted app subnet(s) 1062 contained in the data plane VCN 1018 and the app subnet contained in the container egress VCN 1068. The container egress VCN can include a NAT gateway 1038 that can be communicatively coupled to public Internet 1054 (e.g., public Internet 754 of FIG. 7).

The Internet gateway 1034 contained in the control plane VCN 1016 and contained in the data plane VCN 1018 can be communicatively coupled to a metadata management service 1052 (e.g., the metadata management system 752 of FIG. 7) that can be communicatively coupled to public Internet 1054. Public Internet 1054 can be communicatively coupled to the NAT gateway 1038 contained in the control plane VCN 1016 and contained in the data plane VCN 1018. The service gateway 1036 contained in the control plane VCN 1016 and contained in the data plane VCN 1018 can be communicatively couple to cloud services 1056.

In some examples, the pattern illustrated by the architecture of block diagram 1000 of FIG. 10 may be considered an exception to the pattern illustrated by the architecture of block diagram 900 of FIG. 9 and may be desirable for a customer of the IaaS provider if the IaaS provider cannot directly communicate with the customer (e.g., a disconnected region). The respective containers 1067(1)-(N) that are contained in the VMs 1066(1)-(N) for each customer can be accessed in real-time by the customer. The containers 1067(1)-(N) may be configured to make calls to respective secondary VNICs 1072(1)-(N) contained in app subnet(s) 1026 of the data plane app tier 1046 that can be contained in the container egress VCN 1068. The secondary VNICs 1072(1)-(N) can transmit the calls to the NAT gateway 1038 that may transmit the calls to public Internet 1054. In this example, the containers 1067(1)-(N) that can be accessed in real-time by the customer can be isolated from the control plane VCN 1016 and can be isolated from other entities contained in the data plane VCN 1018. The containers 1067(1)-(N) may also be isolated from resources from other customers.

In other examples, the customer can use the containers 1067(1)-(N) to call cloud services 1056. In this example, the customer may run code in the containers 1067(1)-(N) that requests a service from cloud services 1056. The containers 1067(1)-(N) can transmit this request to the secondary VNICs 1072(1)-(N) that can transmit the request to the NAT gateway that can transmit the request to public Internet 1054. Public Internet 1054 can transmit the request to LB subnet(s) 1022 contained in the control plane VCN 1016 via the Internet gateway 1034. In response to determining the request is valid, the LB subnet(s) can transmit the request to app subnet(s) 1026 that can transmit the request to cloud services 1056 via the service gateway 1036.

It should be appreciated that IaaS architectures 700, 800, 900, 1000 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

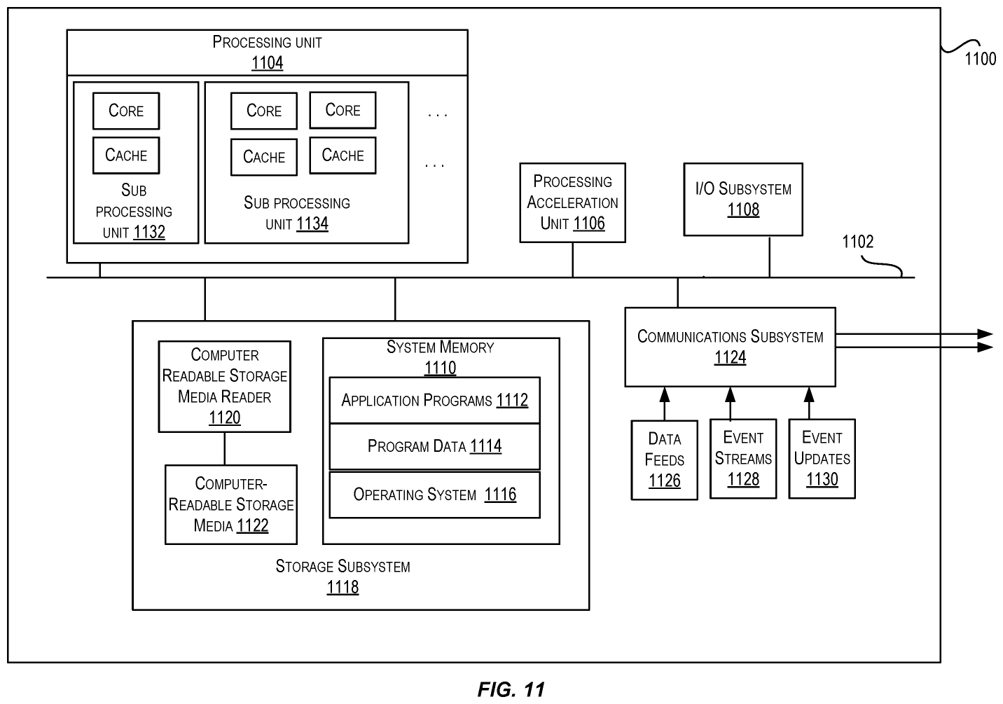

FIG. 11 illustrates an example computer system 1100, in which various embodiments may be implemented. The system 1100 may be used to implement any of the computer systems described above. As shown in the figure, computer system 1100 includes a processing unit 1104 that communicates with a number of peripheral subsystems via a bus subsystem 1102. These peripheral subsystems may include a processing acceleration unit 1106, an I/O subsystem 1108, a storage subsystem 1118 and a communications subsystem 1124. Storage subsystem 1118 includes tangible computer-readable storage media 1122 and a system memory 1110.

Bus subsystem 1102 provides a mechanism for letting the various components and subsystems of computer system 1100 communicate with each other as intended. Although bus subsystem 1102 is shown schematically as a single bus, alternative embodiments of the bus subsystem may utilize multiple buses. Bus subsystem 1102 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1104, which can be implemented as one or more integrated circuits (e.g., a conventional microprocessor or microcontroller), controls the operation of computer system 1100. One or more processors may be included in processing unit 1104. These processors may include single core or multicore processors. In certain embodiments, processing unit 1104 may be implemented as one or more independent processing units 1132 and/or 1134 with single or multicore processors included in each processing unit. In other embodiments, processing unit 1104 may also be implemented as a quad-core processing unit formed by integrating two dual-core processors into a single chip.

In various embodiments, processing unit 1104 can execute a variety of programs in response to program code and can maintain multiple concurrently executing programs or processes. At any given time, some or all of the program code to be executed can be resident in processor(s) 1104 and/or in storage subsystem 1118. Through suitable programming, processor(s) 1104 can provide various functionalities described above. Computer system 1100 may additionally include a processing acceleration unit 1106, which can include a digital signal processor (DSP), a special-purpose processor, and/or the like.

I/O subsystem 1108 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1100 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1100 may comprise a storage subsystem 1118 that comprises software elements, shown as being currently located within a system memory 1110. System memory 1110 may store program instructions that are loadable and executable on processing unit 1104, as well as data generated during the execution of these programs.

Depending on the configuration and type of computer system 1100, system memory 1110 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 1104. In some implementations, system memory 1110 may include multiple different types of memory, such as static random access memory (SRAM) or dynamic random access memory (DRAM). In some implementations, a basic input/output system (BIOS), containing the basic routines that help to transfer information between elements within computer system 1100, such as during start-up, may typically be stored in the ROM. By way of example, and not limitation, system memory 1110 also illustrates application programs 1112, which may include client applications, Web browsers, mid-tier applications, relational database management systems (RDBMS), etc., program data 1114, and an operating system 1116. By way of example, operating system 1116 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems.

Storage subsystem 1118 may also provide a tangible computer-readable storage medium for storing the basic programming and data constructs that provide the functionality of some embodiments. Software (programs, code modules, instructions) that when executed by a processor provide the functionality described above may be stored in storage subsystem 1118. These software modules or instructions may be executed by processing unit 1104. Storage subsystem 1118 may also provide a repository for storing data used in accordance with the present disclosure.

Storage subsystem 1100 may also include a computer-readable storage media reader 1120 that can further be connected to computer-readable storage media 1122. Together and, optionally, in combination with system memory 1110, computer-readable storage media 1122 may comprehensively represent remote, local, fixed, and/or removable storage devices plus storage media for temporarily and/or more permanently containing, storing, transmitting, and retrieving computer-readable information.

Computer-readable storage media 1122 containing code, or portions of code, can also include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer-readable media. This can also include nontangible computer-readable media, such as data signals, data transmissions, or any other medium which can be used to transmit the desired information and which can be accessed by computing system 1100.

By way of example, computer-readable storage media 1122 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1122 may include, but is not limited to, Zip® drives, flash memory cards, universal serial bus (USB) flash drives, secure digital (SD) cards, DVD disks, digital video tape, and the like. Computer-readable storage media 1122 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1100.

Communications subsystem 1124 provides an interface to other computer systems and networks. Communications subsystem 1124 serves as an interface for receiving data from and transmitting data to other systems from computer system 1100. For example, communications subsystem 1124 may enable computer system 1100 to connect to one or more devices via the Internet. In some embodiments communications subsystem %524 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 302.11 family standards, or other mobile communication technologies, or any combination thereof), global positioning system (GPS) receiver components, and/or other components). In some embodiments communications subsystem 1124 can provide wired network connectivity (e.g., Ethernet) in addition to or instead of a wireless interface.

In some embodiments, communications subsystem 1124 may also receive input communication in the form of structured and/or unstructured data feeds 1126, event streams 1128, event updates 1130, and the like on behalf of one or more users who may use computer system 1100.

By way of example, communications subsystem 1124 may be configured to receive data feeds 1126 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1124 may also be configured to receive data in the form of continuous data streams, which may include event streams 1128 of real-time events and/or event updates 1130, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1124 may also be configured to output the structured and/or unstructured data feeds 1126, event streams 1128, event updates 1130, and the like to one or more databases that may be in communication with one or more streaming data source computers coupled to computer system 1100.

Computer system 1100 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1100 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method, comprising:
receiving, by a computing device, a time series comprising a plurality of data points, wherein each data point of the time series comprises a time associated with the data point and a value;
identifying, by the computing device, a first season and a second season from the time series, wherein a length of the first season is a factor of a length of the second season;
estimating, by the computing device, a Fourier order for the first season based at least in part on the length of the first season and the length of the second season;
estimating, by the computing device, a seasonality mode of the first season based at least in part on the length of the first season and the length of the second season; and
selecting, by the computing device, a forecasting model to forecast a value of a future time step of the time series based at least in part on the Fourier order and the seasonality mode.

2. The computer-implemented method of claim 1, wherein the method further comprises:
performing a time-domain analysis on the time series to identify a first plurality of seasons of the time series;
performing a frequency-domain analysis on the time series to identify a second plurality of seasons of the time series;
transforming the second plurality seasons from the frequency-domain to the time-domain;
grouping the first plurality of seasons together with the transformed second plurality of seasons; and
identifying the first season and the second season from the grouping.

3. The computer-implemented method of claim 2, wherein the time-domain analysis is performed via an autocorrelation function, and wherein the frequency-domain analysis is performed via a periodogram function.

4. The computer-implemented method of claim 1, wherein the method further comprises:
analyzing the time series using a mean squared error (MSE) regression analysis; and
identifying the first season based at least in part on the MSE regression analysis.

5. The computer-implemented method of claim 1, wherein estimating the Fourier order comprises dividing the length of the identified second season by the length of the identified first season to obtain a quotient, wherein the estimated Fourier order is based at least in part on the quotient.

6. The computer-implemented method of claim 1, wherein estimating the seasonality mode comprises:
determining a trend of the time series; and
estimating the seasonality mode based at least in part on the trend.

7. The computer-implemented method of claim 1, wherein the seasonality mode comprises an additive seasonality or a multiplicative seasonality.

8. A computing device comprising:
a processor; and
a computer-readable medium comprising instructions stored thereon that, when executed by the processor, cause the processor to:
receive a time series comprising a plurality of data points, wherein each data point of the time series comprises a time associated with the data point and a value;
identify a first season and a second season from the time series, wherein a length of the first season is a factor of a length of the second season;
estimate a Fourier order for the first season based at least in part on the length of the first season and the length of the second season;
estimate a seasonality mode of the first season based at least in part on the length of the first season and the length of the second season; and
select a forecasting model to forecast a value of a future time step of the time series based at least in part on the Fourier order and the seasonality mode.

9. The computing device of claim 8, wherein the instructions further cause the processor to:
perform a time-domain analysis on the time series to identify a first plurality of seasons of the time series;
perform a frequency-domain analysis on the time series to identify a second plurality of seasons of the time series;
transform the second plurality seasons from the frequency-domain to the time-domain;
group the first plurality of seasons together with the transformed second plurality of seasons; and
identify the first season and the second season from the grouping.

10. The computing device of claim 9, wherein the time-domain analysis is performed via an autocorrelation function, and wherein the frequency-domain analysis is performed via a periodogram function.

11. The computing device of claim 8, wherein the instructions further cause the processor to:
analyze the time series using a mean squared error (MSE) regression analysis; and
identify the first season based at least in part on the MSE regression analysis.

12. The computing device of claim 8, wherein estimating the Fourier order comprises dividing the length of the identified second season by the length of the identified first season to obtain a quotient, wherein the estimated Fourier order is based at least in part on the quotient.

13. The computing device of claim 8, wherein estimating the seasonality mode comprises:
determining a trend of the time series; and
estimating the seasonality mode based at least in part on the trend.

14. The computing device of claim 8, wherein the seasonality mode comprises an additive seasonality or a multiplicative seasonality.

15. A non-transitory computer-readable medium comprising stored thereon a sequence of instructions which, when executed by a processor causes the processor to execute a process, the process comprising:
receiving a time series comprising a plurality of data points, wherein each data point of the time series comprises a time associated with the data point and a value;
identifying a first season and a second season from the time series, wherein a length of the first season is a factor of a length of the second season;
estimating a Fourier order for the first season based at least in part on the length of the first season and the length of the second season;
estimating a seasonality mode of the first season based at least in part on the length of the first season and the length of the second season; and
selecting a forecasting model to forecast a value of a future time step of the time series based at least in part on the Fourier order and the seasonality mode.

16. The non-transitory computer-readable medium of claim 15, wherein the process further comprises:
performing a time-domain analysis on the time series to identify a first plurality of seasons of the time series;
performing a frequency-domain analysis on the time series to identify a second plurality of seasons of the time series;
transforming the second plurality seasons from the frequency-domain to the time-domain;
grouping the first plurality of seasons together with the transformed second plurality of seasons; and
identifying the first season and the second season from the grouping.

17. The non-transitory computer-readable medium of claim 16, wherein the time-domain analysis is performed via an autocorrelation function, and wherein the frequency-domain analysis is performed via a periodogram function.

18. The non-transitory computer-readable medium of claim 15, wherein the process further comprises:
analyzing the time series using a mean squared error (MSE) regression analysis; and
identifying the first season based at least in part on the MSE regression analysis.

19. The non-transitory computer-readable medium of claim 15, wherein estimating the Fourier order comprises dividing the length of the identified second season by the length of the identified first season to obtain a quotient, wherein the estimated Fourier order is based at least in part on the quotient.

20. The non-transitory computer-readable medium of claim 15, wherein estimating the seasonality mode comprises:
determining a trend of the time series; and
estimating the seasonality mode based at least in part on the trend.
